(19) United States
(12) Patent Application Publication
(10) Pub. No.: US 2026/0258275 A1
(43) Pub. Date: Sep. 3, 2026

(54) Coating composition for porous substrate

(71) Applicant: Brightplus Oy, Oulu (FI)

(72) Inventors: Maiju Hietala, Oulu (FI); Tuire Marin, Oulu (FI); Rauna-Leena Kuvaja, Oulu (FI); Jarmo Sääski, Oulu (FI); Milja Hannu-Kuure, Oulu (FI); Jarkko Leivo, Oulu (FI)

(21) Appl. No.: 19/162,964

(22) PCT Filed: Mar. 14, 2024
(86) PCT No.: PCT/FI2024/050114

§ 371 Date: Sep. 8, 2025

(30) Foreign Application Priority Data
Mar. 14, 2023 (FI) 20235295

(51) Int. Cl. C09D 167/00; C08K 5/101; C08K 5/20; C08K 11/00; C09D 7/63; C09D 7/65; D06M 15/507

(52) U.S. Cl. CPC C09D 167/00; C08K 5/101; C08K 5/20; C08K 11/00; C09D 7/63; C09D 7/65; D06M 15/507

(57) ABSTRACT

The present invention concerns a biobased or at least partially biobased coating composition for porous substrates, such as textiles. The composition comprises polyester and cellulose ester and is manufactured by using a melt compounding method. In addition, the invention concerns a method for coating or laminating a porous substrate with the coating composition of the present invention.

### BACKGROUND OF THE INVENTION

### Field of the Invention

The present invention concerns a composition comprising a mixture of polyester and cellulose ester, and a coating comprising such composition. In particular, the present invention concerns such coating on a porous substrate and a method for coating or laminating such coating composition on a porous substrate. The invention also concerns a use of such coated or laminated porous substrate.

### Description of Related Art

Protective and repelling properties are required in many applications, and when the substrate itself do not possess such properties, those are usually provided by different kinds of coating layers. In particular, various porous substrates typically have poor repelling properties, wherein protective coatings are required to improve the product life and overall properties of the product. Improved properties obtained by coatings enable applications where the substrate needs protection e.g. from water, light and oxygen. For example, textile coatings are commonly used to provide preferred properties, such as dirt, wind, fire, oil and water resistance, to the textile.

Porous substrates requiring repelling properties typically have a polymeric coating layer to improve its physical properties. Most typically this coating layer is made of fossil-based plastics. Porous substrates made from fibrous material, such as natural fibres, are known to be coated with common coating materials such as polyvinyl chloride (PVC), acrylic resins or polyurethane. Also fluorofunctional plastic films and treatments have been used, comprising for example fluoro siloxanes or perfluoroalkyl and polyfluoroalkyl substances (PFAS). There materials have many desired properties, however, all of these have the drawback of being toxic and/or fossil-based. PVC comprises various dangerous chemicals and additives that are harmful for both human and environment. Acryl is a better alternative from this point view, however, it is also fossil-based and, further, it does not provide as good properties as PVC in terms of tactile properties and dirt resistance, for example. Also manufacture of polyurethane requires use of harmful chemicals.

Use of biopolymers is an attractive option to replace these plastic coatings, and thus bio-based or at least partially bio-based laminate films have been researched for coating different porous substrates. However, there is still need for improvements in terms of bio-based content, protective properties and life cycle of such coated products.

### SUMMARY OF THE INVENTION

The present invention aims at solving at least some of the problems of the prior art. In particular, the present invention provides an environmentally friendly alternative for the prior art solutions.

It is an object of the present invention to provide a new kind of coating composition and a coating thereof for porous substrates, especially for fibre-based porous substrates, such as textiles.

Thus, according to the first aspect the present invention relates to a coating composition comprising a fully or partly biobased polyester and cellulose ester, in particular a mixture of polyester and cellulose ester.

According to the second aspect, the present invention relates to a coating formed from the above-described coating composition.

According to the third aspect, the present invention relates to the above-described coating on a porous substrate. The coating composition can be coated or laminated on the porous substrate to form the coating, i.e. coating layer.

According to the fourth aspect, the present invention relates to a method for coating or laminating a porous substrate with the above-described coating composition.

Thus, the present invention is based on a coating composition, preferably bio-based coating composition, comprising polyester and cellulose ester, especially a mixture of polyester and cellulose ester, and being especially suitable for porous substrates. The composition of the present invention is obtained by melt compounding polyester and a cellulose ester with each other, and the composition thus obtained is applied, by coating or laminating, onto the substrate to form a protective coating layer, improving especially repellency of the substrate.

The use of a melt compounding process provides effective mixing and even heat distribution, which enables efficient mixing between the polyester and the cellulose ester, wherein a biopolymer composition of polyester and cellulose ester is formed.

The coating composition of the present invention, combining biodegradable polyester with cellulose ester, enables formation of thin and flexible coating layer, preferably with protective properties against water and dirt.

The coating layer formed by the coating composition of the present invention can be single layer or a multi-layer coating. In one embodiment, the composition of the present invention provides single-layer coatings with good water repelling properties. Single-layer coatings are thinner than multi-layer coatings, thus requiring less raw material to form a uniform coating, thereby being more economical and ecological. Thinner coating layers also confer improved flexibility of the coating.

In particular, the present invention is characterized by what is stated in the independent claims. Some specific embodiments are defined in the dependent claims.

Several advantages are reached using the present invention. Among others, the method of the invention preferably provides a bio-based and recyclable coating composition for porous substrates. The coating composition of the present invention is generally homophasic. Further, the composition is preferably fully or at least partially made of renewable and/or biodegradable raw materials and it does not comprise any harmful chemicals. Also, recycled raw materials can be used in the composition.

Thus, the invention provides a porous material with a coating composition having good protective/repelling properties combined with biodegradability and/or recyclability. In particular, the coating composition provides improved water and dirt resistance for the porous substrate. Further, the combination is wash-resistant, at least at temperatures up to 40° C. Thereby, the coated or laminated porous substrate of the present invention has an improved service life. The present invention is especially suitable to improve service life of porous substrates made of natural fibres. Thus, the coating composition is especially suitable for fibre-based porous materials, such as different textiles, including tablecloths, clothes and soft furnishings.

The coating composition of the present invention is suitable to be used as a relatively thin coating layer for both rigid and flexible substrates. By applying the composition of the present invention on bio-based, biodegradable, recyclable and/or compostable porous substrates, the present invention ensures the recyclability of the entire material in accordance with the requirements of circular economy, especially with chemical recycling methods.

Thus, the present invention provides durable, washable, repellent and flexible coating composition and a coating thereof, especially for porous substrates. The coating composition can be partly or fully transparent.

In addition, the present method is environmentally friendly, since it enables formation of the composition without solvents due to the use of the melt compounding through melt extrusion, since the melt extrusion enables processing of different viscosities, wherein dissolution of the polyester and cellulose ester in solvent is not needed. Overall, melt extrusion offers high flexibility enabling a continuous process with efficient mixing and short residence time but also an economic production of small amounts of special material.

Next, embodiments will be discussed in more detail.

### EMBODIMENTS

“Room temperature” stands for a temperature of about 15 to 30° C., in particular 15 to 25 5° C., for example about 23° C.

As used herein, the term “about” refers to a value which is ±5% of the stated value.

As used herein, the term “about” refers to the actual given value, and to an approximation to such given value that would reasonably be inferred to one of ordinary skill in the art, including approximations due to the experimental and/or measurement conditions for such given value.

In the present context, the term “biodegradable”, when used in connection of a material, such as polyester, a biopolymer composition or a coating composition, and applied in particular to the organic part thereof, has the conventional meaning of the material being capable of degrading (breaking down) by the action of microorganisms, such as bacteria or fungi or both. Degradation can proceed through aerobic and anaerobic processes and will at the end typically yield carbon dioxide of the organic material. Biodegradation generally takes place in the present of water. Biodegrading the organic matter can be influenced by temperature and pH of the ambient and can take from days to months to even years to completion.

The present invention relates to a coating on a porous substrate, wherein the coating is formed from a composition comprising a mixture of polyester, in particular bio-polyester, and cellulose ester.

According to one preferred embodiment, the polyester is at least 35, 40, 45, 50, 55, 60, 65, 70, 75, 80, 85, 90 or 95 wt. % bio-based, i.e. polyester is 35 to 100% bio-based. Preferably, polyester is 100% bio-based. The amount being calculated from the total weight of the polyester.

In the present context, the term “coating composition” refers to a composition suitable to be used as a coating composition. Such coating composition can be applied onto the substrate by any known method, especially by traditional coating methods in which the coating composition is formed into a layer only on the surface of the substrate, i.e. provided on the substrate in molten form and then cooled, or as a laminate.

Terms “coating” and “coating layer” are used as synonyms referring to the layer formed from the coating composition on the porous substrate. The coating of the present invention can have any thickness, preferably the coating is as thin as possible still capable to provide the desired properties. In a preferred embodiment, the coating has a thickness of less than 100 μm, more preferably less than 80 μm, such as less than 50 μm. The thickness can be for example 20 to 100 μm.

In the context of the present invention the terms “bio” and “biobased” relates to polymers produced from natural sources either chemically synthesized from a biological material or entirely biosynthesized by living organisms.

According to one embodiment, the coating composition is at least 40, 45, 50, 55, 60, 65, 70, 75 or 80 wt. % biobased. In a preferred embodiment, the coating composition is 40 to 80% biobased. The amounts being calculated from the total weight of the coating composition.

The substrate to be coated or laminated can be any porous material. According to the present invention the term “porous” relates to a material that is permeable to gas, liquid, oils or fats or combinations thereof. Typically, the porous material is provided in the form of a sheet, board, plate, or web.

In one embodiment, the porous materials comprise fibrous materials, typically in the form of sheets, boards, plates, or webs. Examples of porous materials for use in embodiments of the present technology include textiles, such as tablecloth, clothe, protective textile, interior textile, consumer device, for example watch strep or heat rate belt. Textile as a porous substrate of the present invention can be made of natural or man-made fiber, preferably natural fiber.

According to a preferred embodiment the substrate is a woven or non-woven fabric or sheet, especially made of natural fibres, such as vegetable fibres (e.g. cellulose, cotton, hemp, flax, ramie, jute, coconut), or animal fibres (e.g. wool, silk).

Thus, the substrate is preferably bio-based. “Bio-based substrates” are materials generally obtained from biological materials, such as biomass (e.g. carbohydrate materials, lignocellulosic materials, in particular in the form of fibrous materials), proteinaceous materials, and lipid-containing materials and combinations thereof. Typically, such materials can be biodegradable, recyclable, repulpable and/or compostable.

In one embodiment, the porous material comprises natural fibers, such as lignocellulosic or cellulosic fibers or combinations thereof.

In one embodiment, the substrate comprises 50 to 100% by weight, in particular 75 to 100% of natural fibers, such as cellulosic or lignocellulosic fibers or combinations thereof, calculated from the total weight of fibrous matter in the substrate, preferably calculated from the total weight of the substrate.

In one embodiment, the substrate material comprises a combination of natural and man-made fibres. Examples of man-made fibres include synthetic fibres such as polyesters and acrylics as well as regenerated fibres, such as fibres made by the viscose process, or Lyocell process or other synthetic fibres comprising materials derived from polysaccharides. In one embodiment, the substrate comprises 10 to 75% by weight of natural fibres and 90 to 25% by weight of man-made fibres, calculated from the total weight of the substrate.

In one embodiment, the porous substrate comprises plastic, i.e. thermoplastic, materials.

The polyester of the coating composition of the present invention can be any polyester, especially biodegradable polyester. It can either be a commercial grade polyester or manufactured using well known polymerization routes. According to a preferred embodiment, the polyester is thermoplastic polyester. Polyester especially provides mechanical strength to the composition.

One or more polyesters can be used in the present invention. For example, two different polyesters can be used in the coating composition. In an embodiment, the polyester(s) is selected from the group of polylactic acid, polylactide, polybutylene succinate, polybutylene succinate adipate, polyhydroxy alkanoate, polyhydroxybutyrate, poly(3-hydroxybutyrate-co-3-hydroxyvalerate), poly(3-hydroxybutyrate-co-3-hydroxyhexanoate), poly (butylene adipate-co-terephthalate), polyethylene furanoate, polycaprolactone, and combinations thereof. These compositions may provide advantageous biodegradability, and flexibility of the composition, and barrier properties to the composition.

Additionally, or alternatively, the composition comprising a mixture of polyester and cellulose ester comprises a mixture of cellulose ester and two or more polyesters, wherein each of the two or more polyesters is independently selected from the group of polylactic acid, polylactide, polybutylene succinate, polybutylene succinate adipate, polyhydroxy alkanoate, polyhydroxybutyrate, poly(3-hydroxybutyrate-co-3-hydroxyvalerate), poly(3-hydroxybutyrate-co-3-hydroxyhexanoate), poly (butylene adipate-co-terephthalate), polyethylene furanoate, and polycaprolactone, and combinations thereof. Having two or more polyesters may provide advantageous biodegradability, and flexibility of the composition, and barrier properties to the composition.

According to a preferred embodiment, polyester is polybutylene succinate (PBS) and/or polybutylene succinate adipate (PBSA), especially PBSA. Preferably, at least 80 wt. %, more preferably at least 90 wt. % of the polyesters are polybutylene succinates and/or polybutylene succinate adipates.

According to one embodiment the composition comprises at least 25, 30, 35, 40, 45, 50, 55, 60, 65, 70, 75, 80, 85, 90 or 95 wt. % of polyester calculated from the total weight of the composition.

According to one embodiment the composition comprises up to 95, 90, 85, 80, 75, 70, 65, 60, 55 or 50 wt. % of polyester calculated form the total weight of the composition.

In a preferred embodiment, the composition comprises 40 to 95 wt. %, preferably 45 to 85 wt. %, more preferably 50 to 70 wt. %, of polyester calculated from the total weight of the composition.

In another preferred embodiment, the composition comprises 30 to 95 wt. %, preferably 30 to 65 wt. %, more preferably 30 to 50 wt. %, of polyester calculated from the total weight of the composition.

Additionally, or alternatively, the composition comprises 25-95 wt. % of polyester calculated from the total weight of the composition, preferably 25-60 wt. %, 30-65 wt. %, or 25-50 wt. % of polyester, more preferably 30-60 wt. % or 30-50 wt. % of polyester, calculated from the total weight of the composition.

The melting temperature of the polyester(s) used in the present invention is typically in the range of 40-300° C., preferably in the range of 80-250° C., most preferably in the range of 120-200° C.

Preferably, the polyester(s) has a melt flow index in the range of 1 g/10 min to 50 g/10 min, preferably in the range of 5 g/10 min to 25 g/10 min, for example a melt flow index of 10 g/10 min. The melt flow indexes being measured by a measurement method comprising loading the plastic polyester granules into a capillary being at temperature of 190° C. A piston and weight of 2.16 kg are placed on top of the granules. Under effect of the weight, the molten polyester is extruded out of the capillary over a period of time, giving the melt flow index.

The cellulose ester of the coating composition of the present invention can be any cellulose ester. According to a preferred embodiment, the cellulose ester is selected from the group of cellulose acetate (CA), cellulose acetate butyrate (CAB), cellulose acetate propionate (CAP) or mixtures thereof. In a preferred embodiment the cellulose ester is CAP or CAB or a combination thereof. Cellulose ester can be especially used to increase transparency and mechanical properties, such as flexibility or durability, of the composition.

According to one embodiment the composition comprises at least 10, 15, 20, 25, 30, 35, 40 or 45 wt. % of cellulose ester calculated from the total weight of the composition.

According to one embodiment the composition comprises up to 45, 40, 35, 30, 25, 20, 15 or 10 wt. % of cellulose ester calculated form the total weight of the composition.

In a preferred embodiment, the composition comprises 10 to 60 wt. %, preferably 20 to 50 wt. %, more preferably 25 to 45 wt. %, for example 30 to 40 wt. %, of cellulose ester calculated form the total weight of the composition.

According to one embodiment, part of the cellulose ester in the composition can be replaced by polyethylene (PE), preferably biobased PE, or polyethylene terephthalate (PET), preferably biobased PET, or polypropylene (PP), preferably biobased PP, or a thermoplastic polyurethane (TPU), preferably a biobased TPU, or a polyamide (PA), preferably a biobased PA, or a mixture thereof. Preferably, amount of the PE, PET, PP, TPU, PA, or a mixture thereof in the coating composition is at most 50 wt. % or at most 25 wt. %, for example 1-20 wt. %, more preferably 5 to 10 wt. %, of the total weight of the coating composition. PE, PET, PP, TPU and/or PA can be used to further increase elasticity and mechanical properties of the composition. PE, PET, PP, TPU and/or PA may be used to further increase the adhesion of the composition to the substrate, processability, wash-resistance and rub durability, optical and haptic properties, and/or thermal stability, and combinations thereof, of the composition.

Additionally, or alternatively, part of the polyester or the two or more polyesters in the composition can be replaced by polyethylene (PE), preferably biobased PE, or polyethylene terephthalate (PET), preferably biobased PET, or polypropylene (PP), preferably biobased PP, or a thermoplastic polyurethane (TPU), preferably a biobased TPU, or a polyamide (PA), preferably a biobased PA, or a mixture thereof. Preferably, amount of the PE, PET, PP, TPU, PA, or a mixture thereof in the coating composition is at most 50 wt. % or at most 25 wt. %, for example 1-20 wt. %, more preferably 5 to 10 wt. %, of the total weight of the coating composition. PE, PET, PP, TPU and/or PA can be used to further increase the adhesion of the composition to the substrate, elasticity, mechanical properties, processability, wash-resistance and rub durability, optical and haptic properties, and/or thermal stability, and combinations thereof, of the composition of the composition. Additionally, or alternatively, the composition comprises or contain a mixture of polyester or two or more polyesters; cellulose ester; and at least one selected from polyethylene (PE), preferably biobased PE; polyethylene terephthalate (PET), preferably biobased PET; polypropylene (PP), preferably biobased PP; a thermoplastic polyurethane (TPU), preferably a biobased TPU; and a polyamide (PA), preferably a biobased PA; or any combination mixture thereof. Preferably, the amount of the PE, PET, PP, TPU, and/or PA, or a mixture thereof in the coating composition is at most 50 wt. % or at most 25 wt. %, for example 1-20 wt. %, more preferably 5 to 10 wt. %, of the total weight of the coating composition. PE, PET, PP, TPU and/or PA can be used to further increase the adhesion of the composition to the substrate, elasticity, mechanical properties, processability, wash-resistance and rub durability, optical and haptic properties, and/or thermal stability, and combinations thereof, of the composition of the composition.

Additionally, or alternatively, the composition comprises or contains a mixture of polyester or two or more polyesters; cellulose ester; and a thermoplastic polyurethane (TPU), preferably a biobased TPU, preferably the amount of TPU in the coating composition is at most 50 wt. % or at most 25 wt. %, or 5-50 wt. %, 25-50 wt. %, or 1-20 wt. %, more preferably 5-10 wt. %, of the total weight of the coating composition. TPU can be used to further increase the adhesion of the composition to the substrate, elasticity, mechanical properties, processability, wash-resistance and rub durability, optical and haptic properties, and/or thermal stability, and combinations thereof, of the composition of the composition.

Additionally, or alternatively, the composition comprises TPU 5-50 wt. %, 25-50 wt. %, or 1-20 wt. %, of the total weight of the coating composition.

According to a preferred embodiment, the coating composition of the present invention has a monophasic structure. Term “monophasic” in the present invention stands for a material of uniform composition throughout that cannot be mechanically separated into different materials.

According to one embodiment, the weight ratio between the polyester and the cellulose ester in the composition is 1:99-99:1, for example 10:99 or 99:10 or 20:80 or 80:20 or 30:70 or 70:30 or 50:50.

According to a preferred embodiment, the weight ratio between the polyester and the cellulose ester in the composition is in the range of 50:50 to 70:30.

According to one embodiment, the composition of the present invention further comprises an additive, especially a plasticizer, such as glycerol, polyethylene glycol, triethyl citrate, tributyl citrate, acetyl tributyl citrate, vegetable oil, such as soybean oil, linseed oil, tall oil, castor oil, canola, or their modification, such as maleated, acrylated, vinylated, succinated, epoxidized, hydroxylated vegetable oil or other vegetable ester oil or resin including epoxidized soybean oil, maleated soybean oil, epoxidized linseed oil, or any combination thereof. Plasticizer especially increases flexibility and settling of the coating. In particular, maleated soybean oil may improve the compatibility of the polyester (or the two or more polyesters) and the cellulose ester, and/or may improve the mechanical properties of the composition. I.e., the maleated soybean oil may be used as a compatibilizer and plasticizer for the composition.

According to one embodiment, the plasticizer is vegetable oil, in particular functionalized vegetable oil, such as maleated soybean oil.

According to a preferred embodiment, the plasticizer is maleated soybean oil, wherein the coating composition further comprises maleated soybean oil. Maleated soybean oil is a modified soybean oil in which some of the unsaturation has been converted to a cyclic dicarboxylic acid.

Thus, according to a preferred embodiment, the coating composition further comprises a plasticizer, preferably maleated soybean oil, in an amount of 1 to 20 wt. %, more preferably 2 to 10 wt. %, for example 3 to 7 wt. %, calculated from the total weight of the composition.

According to one embodiment, the composition of the present invention further comprises an additive, especially a lubricant, such as stearic acid, stearate, for example calcium stearate, magnesium stearate and/or natural wax, such as carnauba wax, soybean wax, beeswax, sugarcane wax, cassava wax, candelilla wax, rice bran wax, berry wax, myrica fruit wax or laurel wax, and/or synthetic wax such as polyamide wax, stearamide such as ethylene-bis-stearamide (EBS) wax (biobased or synthetic), ethylene-bis-oleamide wax, polyethylene wax, Fischer-Tropsch wax, fatty acids and modified fatty acids, hybrid waxes, or any mixture thereof.

Thus, according to a preferred embodiment, the composition further comprises a lubricant, such as stearamide or stearate, preferably calcium stearate, zinc stearate, or ethylene-bis-stearamide, or a mixture thereof. In one embodiment, the amount of the lubricant, preferably stearate or stearamide, is 0.05 to 10 wt. %, preferably 0.1 to 8 wt. %, for example about 0.1 to 3 or 0.1 to 1 wt. %, calculated from the total weight of the composition.

Lubricant affect especially to processability of the composition. Stearates and stearamides, such as EBS, are especially suitable for enhancing the processability as they prevent unnecessary adhering of the coating composition to the processing equipment without coloring the coating composition.

Additionally, or alternatively, the composition further comprises a plasticizer, wherein the plasticizer is maleated soybean oil; and a lubricant, such as stearamide or stearate, preferably calcium stearate, zinc stearate, or ethylene-bis-stearamide, or a mixture thereof, and wherein part of the cellulose ester in the composition is replaced by a thermoplastic polyurethane (TPU).

Additionally, or alternatively, the composition further comprises or contains maleated soybean oil, and a lubricant, and wherein part of the cellulose ester in the composition is replaced by a thermoplastic polyurethane (TPU).

Additionally, or alternatively, the composition further comprises or contains maleated soybean oil, a lubricant, and a thermoplastic polyurethane (TPU).

In one embodiment, the composition further comprises a polysiloxane. According to a preferred embodiment, the polysiloxane is provided in a liquid form. The term “liquid form” in the present invention also comprises a solution. Thus, according to the present invention, material is in a liquid state if it is a liquid as such or dissolved, or at least dispersed, in a medium, preferably in a solvent. Polysiloxane is advantageous since it may bring hydrophobicity to the composition, which may improve waterproofing and water repellency of the composition, and an improved dirt repellency, chemical resistance, and abrasion resistance of the composition may be obtained.

In one embodiment, the composition comprises polysiloxanes in the amount of 0.05 to 10 wt. %, preferably 0.1 to 3 wt. %, for example about 2 wt. %, calculated from the total weight of the composition.

In one embodiment, the composition does not contain any polysiloxanes.

According to one embodiment the polysiloxane mixture is formed by mixing one or several different silane monomers. The silanes are preferably hydrolyzed with an aqueous acid solution, wherein the acid is preferably an organic acid. The content of the acid in the aqueous acid solution is typically in the range of 0.5 to 5 mol-%, for example 1 mol-%, of the aqueous acid solution.

According to one embodiment, the polysiloxane mixture is made of silane monomers having at least one functional group. Preferably, the monomers are selected from the group of methyltriethoxysilane (MTEOS), dimethyldiethoxysilane (DMDEOS), 3-glycidoxypropyl-trimethoxysilane (GPTMS), bis(triethoxysilyl)ethane (BTESE), methyltrimethoxysilane (MTMS), phenyltrimethoxysilane (PTMS) and (3-aminopropyl)triethoxysilane (APTES), ethoxytrimethylsilane (ETMS) and combinations thereof.

According to one embodiment, the polysiloxane mixture is formed in the presence of an acid selected from the group of inorganic acids, comprising nitric acid, hydrochloric acid, sulfuric acid, phosphoric acid and boric acid, or from the group of organic acids, comprising lactic acid, acetic acid, formic acid, citric acid, oxalic acid, uric acid, itaconic acid, fumaric acid, succinic acid, biosuccinic acid, gluconic acid, glutamic acid, malic acid, maleic acid, 2,5-furan dicarboxylic acid, 3-Hydroxypropionic acid, glucaric acid, aspartic acid, levulinic acid and combinations thereof.

One or more organic acids can be used at the same time. The acid acts as catalyst during the hydrolyzation reaction. In addition, it improves compatibility of the polysiloxane with the polymer matrix, i.e. the polyester and the cellulose ester, because the acid can also react with the polyester and/or the cellulose ester.

According to a preferred embodiment, the silane mixture is pre-treated, i.e. the polysiloxane mixture is formed, prior to mixing with the polyester and the cellulose ester. According to one embodiment, the composition of the present invention further comprises an inorganic colorant and/or a filler, especially inorganic filler, such as ashes, minerals, mineral sludges, clays, ceramics and other inorganics comprising for example calcium carbonate, kaolin, talc, gypsum, chalk, mica, wollastonite, glass, silica, alumina, titania and other inorganic oxides, crushed masonry, concrete and other stone and sand like materials, diatomite, metal hydrates, such aluminum hydrates, calcium hydrate, geopolymers and alike.

According to one embodiment, the composition comprises an organic agent, especially organic filler and colorant, such as wood, and plant-based materials and parts and side streams thereof, including beans, for example soybean, bean hull, wheat hull, and rice husk, seaweed, algae, natural resins and gums, carbon, carbon black, biocarbon, woad, willow and other tree bark, onion skin and other vegetable skins, lemon, turmeric root, all natural fibres such as cotton, hemp, flax, pulp, wood fibres; as well as components thereof such as lignocellulose, lignin, suberin, polysaccharides, including natural polysaccharides, such as cellulose, starch and hemicellulose, nanocellulose, and derivatives thereof; and any combinations thereof.

According to one embodiment, the composition of the present invention further comprises a chain extender and/or a cross-linking agent, such as epoxy, peroxide, epoxy, amine or acrylic functionalized chain extenders. In a preferred embodiment the amount of chain extender/cross-linking agent, especially epoxy-functionalized chain extender or peroxide, preferably epoxy-functionalized chain extender, is less than 1.0 wt. % or 0.5 wt. %, preferably 0.01-0.7 wt. %, 0.05-0.7 wt. %, or 0.01-0.2 wt. %, calculated from the total weight of the composition. Additionally, or alternatively, the amount of chain extender/cross-linking agent, especially epoxy-functionalized chain extender, is 0.01-0.7 wt. %, calculated from the total weight of the composition. Chain extenders/cross-linking agents can be used to increase the viscosity of the composition. Higher viscosity, i.e. less flowable composition, may be preferred in some applications, such as for example in film applications. Further, chain extenders/cross-linking agents increase durability of the composition by the bonds formed between the polymer chains. According to a preferred embodiment such components are added to the composition of the present invention after the silane modified polyester is formed in a separate process step. According to another embodiment, such components can be added to the composition at the end phase of the reactive extrusion process, wherein the siloxane and polyester are already mainly reacted.

According to one embodiment, the composition of the present invention further comprises a stabilizing agent, such as light stabilizer, UV stabilizer, antioxidant, heat stabilizer or flame retardant or a mixture thereof. Additionally, or alternatively, the antioxidant is selected from tris(2,4-di-tert-butylphenyl) phosphite (e.g., Irgafos 168), pentaerythritol tetrakis(3-(3,5-di-tert-butyl-4-hydroxyphenyl)propionate) (e.g., Irganox 1010), and octadecyl 3-(3,5-di-tert-butyl-4-hydroxyphenyl)propionate (Irganox 1076). Additionally, or alternatively, the flame retardant is selected from organophophates, and aluminium compounds. These compositions are advantageous since they may enhance the processability of the composition.

Thus, in an embodiment, the composition may further comprise at least one of the following auxiliary agents:
an inorganic colorant and/or a filler, especially inorganic filler, such as ashes, minerals, mineral sludges, clays, ceramics and other inorganics comprising for example calcium carbonate, kaolin, talc, gypsum, chalk, mica, wollastonite, glass, silica, alumina, titania and other inorganic oxides, crushed masonry, concrete and other stone and sand like materials, diatomite, metal hydrates, such as aluminium hydrates, calcium hydrate, geopolymers and alike, or any combination thereof,
an additive, especially a plasticizer, such as glycerol, polyethylene glycol, triethyl citrate, tributyl citrate, acetyl tributyl citrate, vegetable oil, such as soybean oil, linseed oil, tall oil, castor oil, canola, or their modification, such as maleated, acrylated, vinylated, succinated, epoxidized, hydroxylated vegetable oil or other vegetable ester oil or resin including epoxidized soybean oil, maleated soybean oil, epoxidized linseed oil, or any combination thereof,
an organic filler or colorant, such as wood or plant-based material or parts or side streams thereof, including beans, for example soybean, bean hull, wheat hull, and rice husk, seaweed, algae, natural resins and gums, carbon, carbon black, biocarbon, woad, willow and other tree bark, onion skin and other vegetable skins, lemon, turmeric root, all natural fibres such as cotton, hemp, flax, pulp, woodfibres; as well as components thereof such as lignocellulose, lignin, suberin, polysaccharides, including natural polysaccharides, such as cellulose, starch and hemicellulose, nanocellulose, and derivatives thereof; and any combinations thereof,
a chain extender and/or a cross-linking agent, such as epoxy, peroxide, amine or acrylic functionalized chain extender,
a lubricant, including stearamides and stearates such as calcium stearate and magnesium stearates and natural waxes, such as carnauba wax, soybean wax, beeswax, sugarcane wax, cassava wax, candelilla wax, rice bran wax, berry wax, myrica fruit wax and laurel wax, or any mixture thereof, and
a stabilizing agent, such as light stabilizer, UV stabilizer, antioxidant, heat stabilizer or flame retardant or any mixture thereof.

Additionally, or alternatively, the lubricant is selected from stearic acid, a stearate selected from calcium stearate, and magnesium stearate; a natural wax selected from carnauba wax, soybean wax, beeswax, sugarcane wax, cassava wax, candelilla wax, rice bran wax, berry wax, myrica fruit wax, and laurel wax; and a synthetic wax selected from polyamide wax, ethylene-bis-stearamide (EBS) wax (biobased or synthetic), ethylene-bis-oleamide wax, polyethylene wax, Fischer-Tropsch wax, fatty acids and modified fatty acids, and hybrid waxes; or any mixture thereof.

According to one embodiment, the composition comprises in total up to 10, 8, 5, 3 or 1 wt. % of the auxiliary agents described above, such as 0.1 to 10 or 1 to 10 wt. %, preferably 0.5 to 5 wt. %, calculated from the total weight of the composition.

According to one embodiment, at least some of the components of the coating composition are recycled components. Polyester and cellulose ester components can be completely or partly made of recycled polymers. In one embodiment at least 50 wt. % of the total weight of the polyester and the cellulose ester is recycled. The plasticizer additive optionally used can be made completely or partly using of waste or sidestream ingredients.

According to a preferred embodiment, the composition does not contain water or any other solvents.

In one embodiment, the coating composition comprises the combination of polyester, cellulose ester and plasticizer, such as maleated soybean oil.

Thus, according to one embodiment, the compositions comprises, preferably consist of,
40-75 wt. %, preferably 50-70 wt. %, of polyester,
20-50 wt. %, preferably 25-45 wt. % of cellulose ester, and
2-10 wt. % of plasticizer, preferably maleated soybean oil, the amounts being calculated from the total weight of the composition.

Additionally, or alternatively, the composition comprises, preferably consist of,
30-75 wt. %, preferably 30-65 wt. %, more preferably 30-50 wt. %, of polyester,
20-50 wt. %, preferably 25-45 wt. % of cellulose ester,
2-10 wt. % of plasticizer, preferably maleated soybean oil,
0.05-10 wt. %, preferably 0.1-1 wt. %, of lubricant, preferably zinc and/or calcium stearate, and
optionally 0.1-10 wt. %, preferably 0.5-5 wt. %, of any auxiliary agent(s) as disclosed in the present disclosure,
   the amounts being calculated from the total weight of the composition.

According to another embodiment, the composition comprises, preferably consist of,
40-75 wt. %, preferably 50-70 wt. %, of polyester,
20-50 wt. %, preferably 25-45 wt. % of cellulose ester, and
2-10 wt. % of plasticizer, preferably maleated soybean oil,
0.05-10 wt. %, preferably about 0.1-1 wt. %, of stearate, especially zinc and/or calcium stearate, and
optionally 0.1-10 wt. %, preferably 0.5-5 wt. %, of any auxiliary agent(s) of described above,
   the amounts being calculated from the total weight of the composition.

In one embodiment, the composition comprises
50-70 wt. %, of polybutylene succinate,
25-45 wt. % of CAB or CAP,
2-10 wt. % of maleated soybean oil, and
0.1-3 wt. % of zinc and/or calcium stearate,
   the amounts being calculated from the total weight of the composition.

Additionally, or alternatively, the composition comprises, preferably consists of,
30-50 wt. % polyester, preferably polybutylene succinate;
30-50 wt. % cellulose ester, preferably CAB or CAP;
5-25 wt. % thermoplastic polyurethane;
2-10 wt. % maleated soybean oil;
0.2-1.0 wt. % stearate lubricant, preferably zinc and/or calcium stearate;
0.2-1 wt. % chain extender, preferably chain extender BASF Joncryl ADR 4468; and
   the amounts being calculated from the total weight of the composition.

Additionally, or alternatively, the composition comprises, preferably consists of,
20-50 wt. % polyester, preferably polybutylene succinate;
20-50 wt. % cellulose ester, preferably CAB or CAP;
5-50 wt. % thermoplastic polyurethane;
2-10 wt. % maleated soybean oil;
0.2-1.0 wt. % stearate lubricant, preferably zinc and/or calcium stearate;
0.2-1 wt. % chain extender, preferably chain extender BASF Joncryl ADR 4468; and
0.2-1 wt. % antioxidant,
   the amounts being calculated from the total weight of the composition.

Additionally, or alternatively, the composition comprises, preferably consists of,
20-50 wt. % polyester;
20-50 wt. % cellulose ester;
5-50 wt. % thermoplastic polyurethane;
2-10 wt. % maleated soybean oil;
0.2-1.0 wt. %; additive, especially a lubricant, such as stearic acid, stearate, for example calcium stearate, magnesium stearate and/or natural wax, such as carnauba wax, soybean wax, beeswax, sugarcane wax, cassava wax, candelilla wax, rice bran wax, berry wax, myrica fruit wax or laurel wax, and/or synthetic wax such as polyamide wax, stearamide such as ethylene-bis-stearamide (EBS) wax (biobased or synthetic), ethylene-bis-oleamide wax, polyethylene wax, Fischer-Tropsch wax, fatty acids and modified fatty acids, hybrid waxes, or any mixture thereof;
0.2-1 wt. % chain extender, preferably chain extender BASF Joncryl ADR 4468; and
0.2-1 wt. % antioxidant,
   the amounts being calculated from the total weight of the composition.

The present invention also relates to a method for forming a coating composition comprising polyester and cellulose ester in a melt compounding process. The coating composition is characterized by all the same embodiments as described above in the context of the coating composition.

The present invention also relates to a method for forming a coating from the coating composition of the present invention.

In particular, the present invention relates to a method for coating or laminating a porous substrate with such coating composition.

The method of the present invention comprises providing a polyester and a cellulose ester, mixing the polyester and the cellulose ester through melt extrusion in a melt compounding process to form a coating composition and, finally, coating or laminating a surface of the porous substrate with the coating composition to form a coating.

According to one embodiment, the polyester and the cellulose ester can be mixed in a separate vessel prior to feeding into the extruder, wherein the components are fed into the extruder together.

According to another embodiment, the polyester and the cellulose ester can be mixed in the extruder, i.e. the components can be fed separately into the extruder.

According to a preferred embodiment, the polyester is provided in a solid form, preferably as pellets. The pellets are typically dried prior to mixing with the cellulose ester or prior to feeding into the extruder because polyesters typically absorb some moisture from air, which could cause decomposition of the material during processing in high temperatures.

According to one embodiment, if the polyester comprises more than one type of polyester, a polyester blend can be formed by melt compounding the polyesters into a one compound or at least complex. In this case, the polyesters are preferably dried overnight prior to melt compounding and then subjected into an extrusion using an extrusion temperature of about 200°° C. with a screw speed of about 50-350 rpm or preferably about 150-250 rpm.

According to another embodiment, the different polyesters are mixed manually with each other either prior to feeding into the extruder or in the extruder.

Thus, according to one embodiment one or several separate polyester blends can be used,

The same applies to the cellulose ester, i.e. in case of a mixture of different cellulose esters, those can be melt compounded into a one compound or at least complex in a separate melt compounding step, or those can be manually mixed with polyesters prior to feeding into the extruder or in the extruder.

According to a preferred embodiment, the cellulose ester is provided in solid form, preferably as a powder.

Thus, in a preferred embodiment, both polyester and cellulose ester are provided in solid form, preferably as pellets and powder, respectively.

Thus, according to one embodiment of the present invention, the method for producing a coating composition comprising of polyester and cellulose ester, comprises the steps of
providing a polyester.
providing a cellulose ester,
mixing the polyester and the cellulose ester in a melt compounding process.

The method for coating or laminating a porous substrate with such coating composition further comprises the step of coating or laminating a surface of the porous substrate with the coating composition to form a coating, wherein the method comprises the steps of
providing a polyester,
providing a cellulose ester,
mixing the polyester and the cellulose ester through melt extrusion in a melt compounding process, and
coating or laminating the reacted composition on the surface of the porous substrate.

The extrusion in a melt compounding process according to the present invention comprises feeding the components into the extruder, and heating up the components, or at least the polyester and the cellulose ester. Additionally, or alternatively, extrusion in a melt compounding process according to the present disclosure comprises feeding the components into the extruder, mixing the components, and heating up the components, or at least the polyester and the cellulose ester. As already mentioned above, the polyester and the cellulose ester can be mixed either prior to feeding into the extruder, or they can be mixed in the extruder once the polyester and the cellulose ester have melted.

Additionally, or alternatively, the method further comprises providing a plasticizer, wherein the plasticizer is maleated soybean oil; a lubricant, such as stearamide or stearate, preferably calcium stearate, zinc stearate, or ethylene-bis-stearamide, or a mixture thereof; and a thermoplastic polyurethane (TPU), and mixing them with the polyester and the cellulose ester through melt extrusion in a melt compounding process.

Additionally, or alternatively, in providing a cellulose ester, part of the cellulose ester is replaced by a thermoplastic polyurethane (TPU), and the method further comprises providing a plasticizer, wherein the plasticizer is maleated soybean oil; and a lubricant, such as stearamide or stearate, preferably calcium stearate, zinc stearate, or ethylene-bis-stearamide, or a mixture thereof, and the mixing the polyester and the cellulose ester through melt extrusion in a melt compounding process is mixing the polyester, the cellulose ester, the TPU, the plasticizer, and the lubricant through melt extrusion in a melt compounding process.

Additionally, or alternatively, the mixing the polyester and the cellulose ester through melt extrusion in a melt compounding process comprises providing a plasticizer, wherein the plasticizer is maleated soybean oil; a lubricant, such as stearamide or stearate, preferably calcium stearate, zinc stearate, or ethylene-bis-stearamide, or a mixture thereof; and a thermoplastic polyurethane (TPU), and mixing the polyester and the cellulose ester with the plasticizer, the lubricant, and the TPU through melt extrusion in a melt compounding process.

Typically, the extruder used in the present invention is a twin screw extruder, preferably a co-rotating twin screw extruder. Twin screw extruder has excellent mixing capability at the molecular level, which enables production of homogeneous material composition.

Preferably, the melt extrusion is performed at a temperature higher than the melting temperature of both the polyester and the cellulose ester. According to a preferred embodiment, the melt extrusion is performed at a temperature of at least 150° C., 160° C., 170° C., 180° C., 190° C. or 200° C., for example at about 200° C., such as in the range of 150 to 250° C. or in the range of 180 to 220° C.

The screw speed used in the extrusion is preferably in the range of 50 to 350 rpm, more preferably in the range of 50 to 200 rpm or in the range of 50 to 250 rpm, more preferably in the range of 50 to 250 rpm, for example 150 rpm.

During the extrusion, the components are compounded into a biopolymer composition.

According to one embodiment, the mixture is compounded in the extrusion into strands. According to a further embodiment the strands are optionally cooled in water bath. Finally, the cooled strands can be pelletized into granules.

According to one embodiment, the method comprises providing further components, such as additives or auxiliary agents into the coating composition.

In one preferred embodiment, the method comprises further providing a plasticizer, such as maleated soybean oil, and/or a lubricant, in particular stearate, such as calcium and/or zinc stearate, into the coating composition. Preferably, the optional additives, such as plasticizer and/or lubricant, are mixed with the polyester and the cellulose ester through melt extrusion in a melt compounding process. Plasticizer and/or lubricant can be separately added into the extruder or all or at least some of the components can be mixed with each other prior to feeding into the extruder. Lubricant can for example be fed into the extruder by side feeder and plasticizer by a pump.

According to one embodiment, the method comprises further providing polysiloxane(s) into the coating composition. In a preferred embodiment, the polysiloxane being in a liquid form is mixed with polyester and cellulose ester being in a solid forms, i.e. the polysiloxane and the polyester and the cellulose ester are mixed prior to melt compounding, wherein the liquid polysiloxane mixture stays on the surface of the polyesters and cellulose esters and the reactions occur during the extrusion once the polyester and cellulose ester melt.

According to another embodiment, the polysiloxane, being in a liquid form, is mixed with a melted polyester and cellulose ester using liquid feeding, wherein reactions occur during extrusion once the components mix with each other.

According to one embodiment, at least some of the components of the coating composition are mixed already prior to feeding into the extruder.

According to one embodiment, the method of the present invention can be repeated for the biopolymer composition formed in the present invention in order to further modify the properties of the composition. For example, according to one embodiment of the present invention, the composition can be combined with another polyester blend.

As being said, according to one embodiment, the molten biopolymer composition exiting the extruder is granulated using for example strand pelletizing or underwater pelletizing system. In strand pelletizing, the strand or strands exiting the extruder are cooled and solidified in a cooled water bath, and subsequently cut into biopolymer granulates using a pelletizer device. In underwater pelletizing, the cutting occurs right after the extruder die by rotating blades where circulated process water cools the polymer melt. After pelletization, the polymer granulates are preferably dried in a dryer or air-circulation oven.

The coating composition is then coated or laminated onto the surface of the porous substrate.

In one embodiment, the polymer granulates are melted again in the coating process, which can be for example hot-melt coating or extrusion coating, or, in a film making process before the lamination coating.

According to one embodiment, the method of the present invention can comprise foaming the obtained composition to obtain a foamed coating composition. The composition can be foamed by any known foaming method, such as by chemical or physical foaming using for example foam extrusion and carbon dioxide, nitrogen, pentane, or any combination thereof as blowing agent. The foamed coating composition can then be coated or laminated on the substrate as described above.

According to one embodiment, the porous substrate is coated with the coating composition by hot melt coating. In one embodiment, the coating composition granulates are first melted e.g. in an extruder, after which the molten coating composition is transferred into the gap of two heated calendaring rolls. From the rolls the molten coating is transferred into the substrate via and subsequent calendaring rolls smooth and apply pressure to the coated substrate to obtain even and thin coating layer.

According to another embodiment, the porous substrate is laminated with the coating composition. Thus, the coating composition is first formed into a film of a desired thickness (e.g. 20 μm to 100 μm) using either film blowing or film extrusion technique.

The formed film can be then laminated onto the surface of the porous substrate. In the thermal lamination process the film to be laminated is applied onto a substrate using heated pressure rollers which are used to fuse the film onto a substrate.

One or both of surfaces of the porous substrate can be coated or laminated. Also, part of the surface(s) or the whole surface(s) can be coated or laminated.

According to a further embodiment, the coated or laminated surface of the porous substrate, i.e. formed coating, can be further treated, especially patterned and/or perforated. In a preferred embodiment, the pattering and/or perforation is made by pressing, especially by pressing with a patterned mold, a perforation roll, or an embossing roll.

According to one embodiment, an adhesive layer can be used between the porous substrate and the coating layer or laminate layer, especially between the porous substrate and the laminate layer. Such adhesive layer can be for example a starch glue.

Additionally, or alternatively, the composition further comprises an adhesion promoter. Examples of adhesion promotors include, but are not limited to, coatosil, and BYK, such as Coatosil 2287 (organofunctional silane ester, CAS: 2897-60-1), BYK 4509, BYK 4510, BYK4511, BYK4512. An adhesion promotor in the composition is advantageous since the composition may have an increased adhesion to the substrate.

Patterning and/or perforation can be carried out with or without heating. Patterning can be also carried out with or without the means of additive manufacturing and radiation curing.

Pattering and/or perforation can be performed straight after coating or lamination, or it can be performed later in a separate process step.

According to one embodiment, the coating composition of the present invention can be further coated or laminated with a hard coating, i.e. protective coating. Hard coating can be especially useful to protect patterned and/or perforated surface. Hard coating can be any polymer with good adhesion with the coating material providing improved wear resistance, for example an acrylate or polysiloxane-based hybrid coating.

Further, the present invention relates to the use of the porous substrate coated with the coating composition. Such coated substrate, especially textile substrate, finds several uses in consumer textiles, such as tablecloth or interior textile.

In general, the present invention can be used to produce porous substrates having a biopolymer coating, and generally for replacement of conventional methods of producing coated porous substrates.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1

### Preparation of Maleated Soybean Oil 1

8.93 kg of soybean oil, 1.25 kg of maleic anhydride and catalyst (8.93 g of Sn(Oct)₂ ) were added to a reactor. Further, nitrogen was added as an inert gas to the reaction vessel. The reaction mixture was heated to 180° C. while stirring. Maleation reaction was continued for 10-12 hours.

### Preparation of Coating Composition 1

196 kg of commercial grade polybutylene succinate (BioPBS FD 92B) and 87 kg of cellulose acetate butyrate (CAB 381.05) were dried overnight in circulated air oven at 60° C. and then mixed together prior to melt compounding. The obtained mixture was melt compounded using a twin-screw extrusion with extrusion temperature of 150° C.-170° C. and screw speed of 285 rpm. During compounding, a side hopper was used to feed 2 kg of calcium stearate-zinc stearate mixture (1:1) in to the compound. In addition, 15 kg of the maleated soybean oil 1 was pumped into the extruder during compounding. The compounded material was extruded into strands, cooled in water bath and pelletized into granules.

### Coating the Substrate

Cotton fabric substrate with a grammage of 185 g/m² was coated with the coating composition 1 using an extrusion coating method.

The coating composition melted in an extruder using temperature of 150° C.-170° C. and extruded through the flat die onto the nip of the coating rolls and transferred to the fabric substrate. Coating rolls spread the coating into a uniform layer and the coating cured while cooling. A cotton fabric with a coating thickness of 80-150 g/m² was obtained.

### Example 2

### Preparation of Maleated Soybean Oil 2

120 g of soybean oil, 25.2 g of maleic anhydride and catalyst (120 ul of Sn(Oct)₂ ) were added to a beaker. Nitrogen blanket was added and reaction mixture was heated to 200° C. while stirring. Maleation reaction was continued for 6 hours.

### Preparation of Coating Composition 2

148 kg of commercial grade polybutylene succinate (BioPBS FD 92B) and 135 kg of cellulose acetate propionate (CAP 482.05) were dried overnight in circulated air oven at 60° C. Dried polybutylene succinate and cellulose acetate propionate were mixed together with 15 kg of the maleated soybean oil 2 and 2 kg of calcium stearate-zinc stearate mixture (1:1) prior to melt compounding. The obtained mixture was melt compounded using a twin-screw extrusion with extrusion temperature of 180° C.-200° C. and screw speed of 165 rpm. The compounded material was extruded into strands, cooled in water bath and pelletized into granules.

### Coating the Substrate

Cotton fabric with a grammage of 185 g/m² was coated with the coating composition 2 using hot-melt coating. The coating composition granulate was first melted in an extruder, after which the molten coating composition was placed into the gap of two heated calendaring rolls with temperatures between 165-175° C. The molted composition was transferred from the calendaring rolls into the fabric after which the subsequent calender rolls further smoothed and applied pressure to the coating of the cotton fabric to obtain fabric with coating thickness of 75-120 g/m².

The same experiment was also performed with other vegetable oils, such as castor and linseed oil with corresponding outcome.

### Example 3

### Preparation of Coating Composition 3

161 kg of commercial grade polybutylene succinate (BioPBS FD 92B) and 120 kg of cellulose acetate propionate (CAP 482.20) were dried overnight in circulated air oven at 60° C. Dried polybutylene succinate and cellulose acetate propionate were mixed with 18 kg of triethyl citrate (TEC) and 0.9 kg of calcium stearate-zinc stearate mixture (1:1) prior to melt compounding. The obtained mixture was melt compounded using a twin-screw extrusion with extrusion temperature of 200° C. and screw speed of 200 rpm. The compounded material was extruded into strands, cooled in water bath and pelletized into granules.

### Example 3b

### Preparation of Coating Compostions 3b

117 kg of commercial grade polybutylene succinate (BioPBS FD 92B), 117 kg of cellulose acetate propionate (CAP 482.05) and 45 kg partly (46 wt. %, rest being non bio-based) bio-based thermoplastic polyurethane (TPU) were dried overnight in a circulated air oven at 60-80° C. The dried polybutylene succinate, cellulose acetate propionate and thermoplastic polyurethane were mixed with

3.0 kg of ethylene-bis-stearamide wax, 1.5 kg of tris(2,4-di-tert-butylphenyl) phosphite antioxidant, 1.5 kg epoxy-functionalized chain extender (Joncryl ADR 4468) prior to melt compounding. The obtained mixture was melt compounded using a twin-screw extrusion with extrusion temperature of 200° C. and screw speed of 200 rpm. In addition, 15 kg of the maleated soybean oil 1 prepared in example 1 was pumped into the extruder during compounding. The compounded material was extruded into strands, cooled in a water bath and pelletized into granules.

### Coating the Substrate 3c

Cotton fabric with a grammage of 185 g/m² was coated with the coating composition 3 using hot-melt coating. The coating composition granulate was first melted in an extruder, after which the molten coating composition was placed into the gap of two heated calendaring rolls with temperatures between 165-175° C. The molted composition was transferred from the calendaring rolls into the fabric after which the subsequent calender rolls further smoothed and applied pressure to the coating of the cotton fabric to obtain fabric with coating thickness of 75-120 g/m².

### Coating the Substrate 3d

Cotton fabric with a grammage of 185 g/m² was coated with the coating composition 3b using hot-melt coating. The coating composition granulate was first melted in an extruder, after which the molten coating composition was placed into the gap of two heated calendaring rolls with temperatures between 145-165° C. The molted composition was transferred from the calendaring rolls into the fabric after which the subsequent calender rolls further smoothed and applied pressure to the coating of the cotton fabric to obtain fabric with coating thickness of 75-120 g/m².

### Example 4

### Preparation of Mixture 1 (Polysiloxane Mixture)

225 g of aqueous biosuccinic acid solution (1 wt.-% of biosuccinic acid was diluted in deionized water) was gradually added to 1500 g of methyltriethoxysilane. The solution was mixed 12 hours at room temperature prior to use.

### Preparation of Biobased Compound 4

47.6 kg of commercial grade polybutylene succinate (BioPBS FD 92B) and 21.7 kg of cellulose acetate butyrate (CAB 381.05) were dried overnight in circulated air oven at 60° C. and then mixed together prior to melt compounding. The obtained mixture was melt compounded using a twin-screw extrusion with extrusion temperature of 200° C. and screw speed of 250 rpm. During compounding, a side hopper was used to feed 0.45 kg of calcium stearate-zinc stearate mixture (1:1) into the compound. In addition, 3.75 kg of maleated soybean oil and 1.5 kg of polysiloxane mixture (mixture 1) were pumped in the extruder during compounding. The compounded material was extruded into strands, cooled in water bath and pelletized into granules.

### Coating the Substrate

Cotton fabric with a grammage of 185 g/m² was coated with the coating composition 4 using hot-melt coating. The coating composition granulate was first melted in an extruder, after which the molten coating composition was placed into the gap of two heated calendaring rolls with temperatures between 165-175° C. The molted composition was transferred from the calendaring rolls into the fabric after which the subsequent calender rolls further smoothed and applied pressure to the coating of the cotton fabric to obtain fabric with coating thickness of 75-120 g/m^{2.}

### Example 5

### Preparation of Biobased Compound 5

222 kg of commercial grade polybutylene succinate (BioPBS FD 92B) and 60 kg of cellulose acetate propionate (CAB 381.05) were dried overnight in circulated air oven at 60° C. Dried polybutylene succinate and cellulose acetate butyrate were mixed with 15 kg of polyethylene glycol 400 (PEG 400) and 1 kg of calcium stearate-zinc stearate mixture (1:1) prior to melt compounding. The obtained mixture was melt compounded using a twin-screw extrusion with extrusion temperature of 200° C. and screw speed of 200 rpm. The compounded material was extruded into strands, cooled in water bath and pelletized into granules.

### Coating the Substrate

Cotton fabric with a grammage of 185 g/m² was coated with the coating composition 5 using hot-melt coating. The coating composition granulate was first melted in an extruder, after which the molten coating composition was placed into the gap of two heated calendaring rolls with temperatures between 165-175° C. The molted composition was transferred from the calendaring rolls into the fabric after which the subsequent calender rolls further smoothed and applied pressure to the coating of the cotton fabric to obtain fabric with coating thickness of 75-120 g/m².

1-19. (canceled)

20. A coating on a porous substrate, wherein the coating is formed from a composition comprising:
a mixture of polyester and cellulose ester,
a plasticizer, wherein the plasticizer comprises maleated soybean oil,
a lubricant, and
a thermoplastic polyurethane (TPU).

21. The coating according to claim 20, wherein the substrate comprises a fiber-based material.

22. The coating according to claim 20, wherein the polyester is selected from the group of polylactic acid, polylactide, polybutylene succinate, polybutylene succinate adipate, polyhydroxy alkanoate, polyhydroxybutyrate, polycaprolactone, and combinations thereof.

23. The coating according to claim 20, wherein the composition comprises 25-95 wt. % of the polyester calculated from the total weight of the composition.

24. The coating according to claim 20, wherein the composition comprises 45-85 wt. % of the polyester calculated from the total weight of the composition.

25. The coating according to claim 20, wherein the cellulose ester comprises cellulose acetate (CA), cellulose acetate butyrate (CAB), cellulose acetate propionate (CAP), or a mixture thereof.

26. The coating according to claim 20, wherein the composition comprises 10-60 wt. % of the cellulose ester calculated from the total weight of the composition.

27. The coating according to claim 20, wherein the composition comprises the maleated soybean oil in an amount of 1 to 20 wt. %, calculated from the total weight of the composition.

28. The coating according to claim 20, wherein the composition comprises the lubricant in an amount of 0.05 to 10 wt. %, calculated from the total weight of the composition.

29. The coating according to claim 20, wherein the composition further comprises polysiloxane or a mixture of polysiloxanes, in the amount of 0.05 to 10 wt. % calculated from the total weight of the composition.

30. The coating according to claim 20, wherein the composition further comprises at least one of the following auxiliary agents:
an inorganic colorant and/or a filler,
a plasticizer,
an organic agent,
a chain extender and/or a cross-linking agent, or
a stabilizing agent.

31. The coating according to claim 20, wherein the composition does not contain water or any other solvents.

32. The coating according to claim 20, wherein the composition consists of
30-75 wt. % of the polyester,
20-50 wt. % of the cellulose ester,
2-10 wt. % of the plasticizer,
0.05-10 wt. % of the lubricant, and
optionally 0.1-10 wt. % of any auxiliary agent(s) selected from the group of an inorganic colorant and/or a filler, a plasticizer, an organic agent, a chain extender and/or a cross-linking agent, and a stabilizing agent,
the amounts being calculated from the total weight of the composition.

33. The coating according to claim 20, wherein the composition consists of
50-70 wt. % of the polyester, wherein the polyester comprises polybutylene succinate, polybutylene succinate adipate, or a combination thereof,
25-45 wt. % of the cellulose ester, wherein the cellulose ester comprises cellulose acetate butyrate, cellulose acetate propionate, or a combination thereof,
2-10 wt. % of the maleated soybean oil, and
0.1-3 wt. % of the lubricant, wherein the lubricant comprises zinc stearate, calcium stearate, or a combination thereof,
the amounts being calculated from the total weight of the composition.

34. A method for coating or laminating a porous substrate, comprising the steps of
providing a polyester, a cellulose ester, a plasticizer, a lubricant, and a thermoplastic polyurethane (TPU),
mixing the polyester, the cellulose ester, the plasticizer, the lubricant, and the thermoplastic polyurethane (TPU) through melt extrusion in a melt compounding process to form a coating composition, and
coating or laminating a surface of the porous substrate with the coating composition to form a coating, wherein the plasticizer comprises maleated soybean oil.

35. The method according to claim 34, wherein the composition is compounded in a twin-screw extruder.

36. The method according to claim 34, wherein the extrusion is performed at a temperature higher than the melting temperature of the polyester and the cellulose ester.

37. The method according to claim 34, wherein the porous substrate is coated with the coating composition by hot melt coating or laminated with a film formed by the coating composition.

38. The method according to claim 34, wherein the formed coating is patterned and/or perforated.

39. The coating according to claim 20, wherein the lubricant comprises a stearamide or a stearate, or a combination thereof.
